(19) United States
(12) Patent Application Publication
(10) Pub. No.: US 2021/0392413 A1
(43) Pub. Date: Dec. 16, 2021

(54) Storage System and Method for Data Peeling

(71) Applicant: Western Digital Technologies, Inc., San Jose, CA (US)

(72) Inventor: Ramanathan Muthiah, Bangalore (IN)

(73) Assignee: Western Digital Technologies, Inc., San Jose, CA (US)

(21) Appl. No.: 16/899,250

(22) Filed: Jun. 11, 2020

(51) Int. Cl. H04N 21/845; H04N 21/433; H04N 21/218

(52) U.S. Cl. CPC H04N 21/8451; H04N 21/2182; H04N 21/433

(57) ABSTRACT

A storage system and method for data peeling are provided. In one embodiment, a controller of the storage system is configured to receive a request from a host for a reduced-bit-rate version of video stored in the memory suitable for a specified profile; generate the reduced-bit-rate version of the video; and send the reduced-bit-rate version of the video to the host. Other embodiments are provided.

### BACKGROUND

In some environments, a playback system is connected to a host over a network. When the playback system wants to play video data, the playback system sends a request over the network to the host. The host retrieves the video data from a memory in a storage system and then sends the video data over the network to the playback system. If bandwidth consumption on the network is high, the video data may need to be buffered on the host until more bandwidth becomes available.

### BRIEF DESCRIPTION OF THE DRAWINGS

FIG. 1A is a block diagram of a non-volatile storage system of an embodiment.

FIG. 1B is a block diagram illustrating a storage module of an embodiment.

FIG. 1C is a block diagram illustrating a hierarchical storage system of an embodiment.

FIG. 2A is a block diagram illustrating components of the controller of the non-volatile storage system illustrated in FIG. 1A according to an embodiment.

FIG. 2B is a block diagram illustrating components of the non-volatile memory storage system illustrated in FIG. 1A according to an embodiment.

FIG. 3 is a block diagram of a host and storage system of an embodiment.

FIG. 4 is a flow diagram illustrating communication between a host and a storage system of an embodiment.

### DETAILED DESCRIPTION

Overview

By way of introduction, the below embodiments relate to a storage system and method for data peeling. In one embodiment, a storage system is provided comprising a memory and a controller. The controller is configured to receive a request from a host for a reduced-bit-rate version of video stored in the memory suitable for a specified profile; generate the reduced-bit-rate version of the video; and send the reduced-bit-rate version of the video to the host.

In some embodiments, the specified profile is based on a playback condition determined by the host.

In some embodiments, the playback condition comprises available network bandwidth between the host and a playback system.

In some embodiments, the playback condition comprises a playback capability of a playback system connected with the host.

In some embodiments, the controller is further configured to select a profile that is a best fit for the specified profile, wherein the reduced bit rate is associated with the selected profile.

In some embodiments, the controller is further configured to inform the host of the selected profile.

In some embodiments, the video comprises an advanced video coding (AVC) video.

In some embodiments, the memory comprises a three-dimensional memory.

In another embodiment, a method is provided that is performed in a host in communication with a playback system and a storage system. The method comprises determining a playback condition; based on the determined playback condition, sending a request to the storage system for a desired profile for video data stored in a memory of the storage system; receiving, from the storage system, a reduced-bit-rate version of the video data, wherein the reduced-bit-rate version of the video data is a better fit for the desired profile than the video data stored in the memory of the storage system; and sending the reduced-bit-rate version of the video data to the playback system.

In some embodiments, the playback condition comprises available network bandwidth between the host and the playback system.

In some embodiments, the playback condition comprises playback capability of the playback system.

In some embodiments, the method further comprises receiving a hint from the storage system regarding a profile chosen by the storage system in response to the request for the desired profile.

In some embodiments, the video data comprises advanced video coding (AVC) data.

In another embodiment, a storage system is provided comprising a memory; means for receiving a playback condition from a host; and means for data peeling a media file stored in the memory to generate a lower bit-rate version of the media file, wherein the lower bit rate is suitable for the playback condition.

In some embodiments, the playback condition comprises available network bandwidth between the host and a playback system.

In some embodiments, the playback condition comprises a playback capability of a playback system connected with the host.

In some embodiments, the storage system further comprises means for selecting a profile that is appropriate for the playback condition.

In some embodiments, the storage system further comprises means for informing the host of the selected profile.

In some embodiments, the media file comprises video data.

In some embodiments, the media file comprises audio data

Other embodiments are possible, and each of the embodiments can be used alone or together in combination. Accordingly, various embodiments will now be described with reference to the attached drawings.

### Embodiments

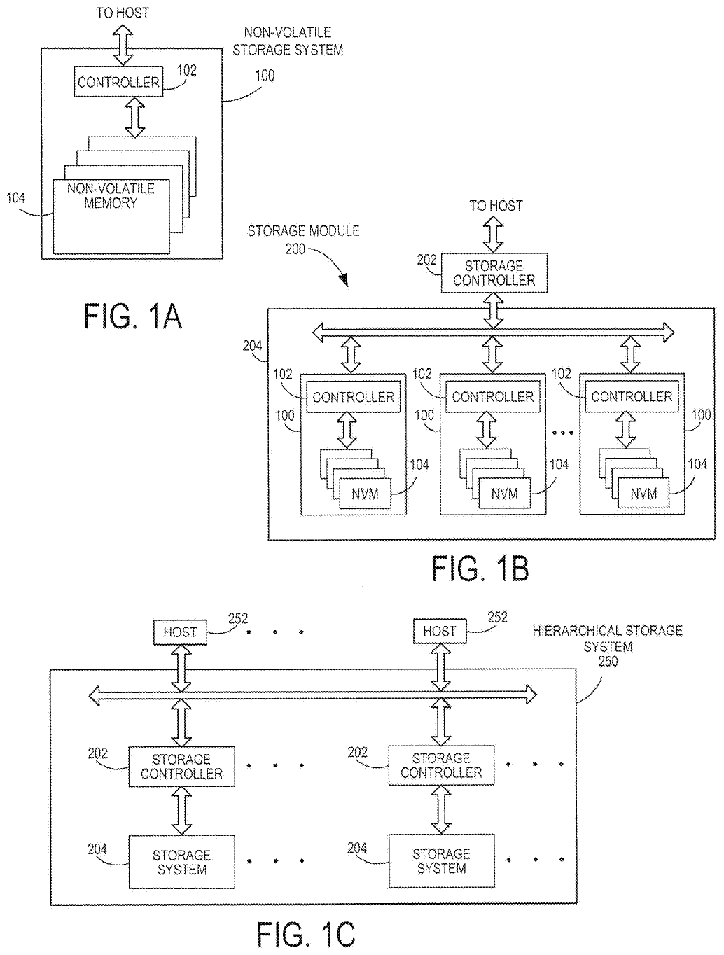

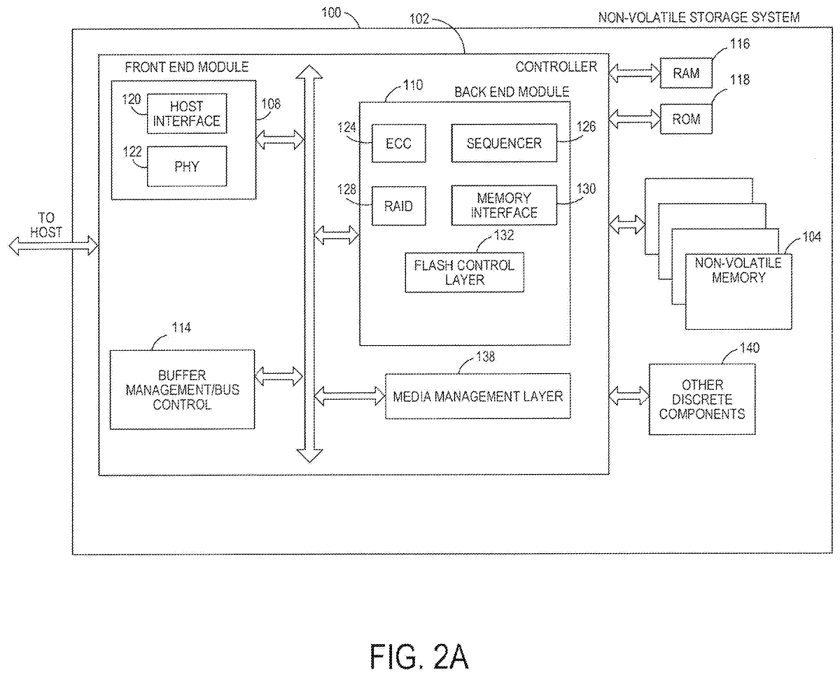

Storage systems suitable for use in implementing aspects of these embodiments are shown in FIGS. 1A-1C. FIG. 1A is a block diagram illustrating a non-volatile storage system 100 according to an embodiment of the subject matter described herein. Referring to FIG. 1A, non-volatile storage system 100 includes a controller 102 and non-volatile memory that may be made up of one or more non-volatile memory die 104. As used herein, the term die refers to the collection of non-volatile memory cells, and associated circuitry for managing the physical operation of those non-volatile memory cells, that are formed on a single semiconductor substrate. Controller 102 interfaces with a host system and transmits command sequences for read, program, and erase operations to non-volatile memory die 104.

The controller 102 (which may be a non-volatile memory controller (e.g., a flash, resistive random-access memory (ReRAM), phase-change memory (PCM), or magnetoresistive random-access memory (MRAM) controller)) can take the form of processing circuitry, a microprocessor or processor, and a computer-readable medium that stores computer-readable program code (e.g., firmware) executable by the (micro)processor, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can also be stored external to the controller, and other components can be used. Additionally, the phrase “operatively in communication with” could mean directly in communication with or indirectly (wired or wireless) in communication with through one or more components, which may or may not be shown or described herein.

As used herein, a non-volatile memory controller is a device that manages data stored on non-volatile memory and communicates with a host, such as a computer or electronic device. A non-volatile memory controller can have various functionality in addition to the specific functionality described herein. For example, the non-volatile memory controller can format the non-volatile memory to ensure the memory is operating properly, map out bad non-volatile memory cells, and allocate spare cells to be substituted for future failed cells. Some part of the spare cells can be used to hold firmware to operate the non-volatile memory controller and implement other features. In operation, when a host needs to read data from or write data to the non-volatile memory, it can communicate with the non-volatile memory controller. If the host provides a logical address to which data is to be read/written, the non-volatile memory controller can convert the logical address received from the host to a physical address in the non-volatile memory. (Alternatively, the host can provide the physical address.) The non-volatile memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including resistive random-access memory (ReRAM), magnetoresistive random-access memory (MRAM), phase-change memory (PCM), NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, storage system 100 may be a card based system, such as a secure digital (SD) or a micro secure digital (micro-SD) card. In an alternate embodiment, storage system 100 may be part of an embedded storage system.

Although, in the example illustrated in FIG. 1A, non-volatile storage system 100 (sometimes referred to herein as a storage module) includes a single channel between controller 102 and non-volatile memory die 104, the subject matter described herein is not limited to having a single memory channel. For example, in some storage system architectures (such as the ones shown in FIGS. 1B and 1C), 2, 4, 8 or more memory channels may exist between the controller and the memory device, depending on controller capabilities. In any of the embodiments described herein, more than a single channel may exist between the controller and the memory die, even if a single channel is shown in the drawings.

FIG. 1B illustrates a storage module 200 that includes plural non-volatile storage systems 100. As such, storage module 200 may include a storage controller 202 that interfaces with a host and with storage system 204, which includes a plurality of non-volatile storage systems 100. The interface between storage controller 202 and non-volatile storage systems 100 may be a bus interface, such as a serial advanced technology attachment (SATA), peripheral component interconnect express (PCIe) interface, or double-data-rate (DDR) interface. Storage module 200, in one embodiment, may be a solid state drive (SSD), or non-volatile dual in-line memory module (NVDIMM), such as found in server PC or portable computing devices, such as laptop computers, and tablet computers.

FIG. 1C is a block diagram illustrating a hierarchical storage system. A hierarchical storage system 250 includes a plurality of storage controllers 202, each of which controls a respective storage system 204. Host systems 252 may access memories within the storage system via a bus interface. In one embodiment, the bus interface may be a Non-Volatile Memory Express (NVMe) or fiber channel over Ethernet (FCoE) interface. In one embodiment, the system illustrated in FIG. 1C may be a rack mountable mass storage system that is accessible by multiple host computers, such as would be found in a data center or other location where mass storage is needed.

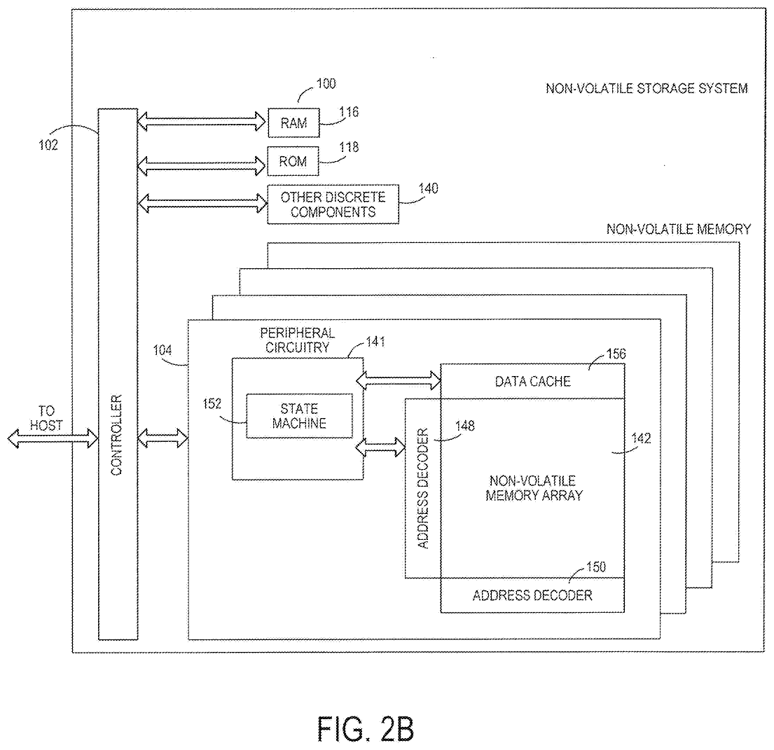

FIG. 2A is a block diagram illustrating components of controller 102 in more detail. Controller 102 includes a front end module 108 that interfaces with a host, a back end module 110 that interfaces with the one or more non-volatile memory die 104, and various other modules that perform functions which will now be described in detail. A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example.

Referring again to modules of the controller 102, a buffer manager/bus controller 114 manages buffers in random access memory (RAM) 116 and controls the internal bus arbitration of controller 102. A read only memory (ROM) 118 stores system boot code. Although illustrated in FIG. 2A as located separately from the controller 102, in other embodiments one or both of the RAM 116 and ROM 118 may be located within the controller. In yet other embodiments, portions of RAM and ROM may be located both within the controller 102 and outside the controller.

Front end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, serially attached small computer system interface (SAS), Fibre Channel, universal serial bus (USB), PCIe, and NVMe. The host interface 120 typically facilitates transfer for data, control signals, and timing signals.

Back end module 110 includes an error correction code (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the memory device 104. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. A flash control layer 132 controls the overall operation of back end module 110.

The storage system 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller 114 are optional components that are not necessary in the controller 102.

FIG. 2B is a block diagram illustrating components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including ReRAM, MRAM, PCM, NAND flash memory cells and/or NOR flash memory cells in a two dimensional and/or three dimensional configuration. Non-volatile memory die 104 further includes a data cache 156 that caches data. Peripheral circuitry 141 includes a state machine 152 that provides status information to the controller 102.

Returning again to FIG. 2A, the flash control layer 132 (which will be referred to herein as the flash translation layer (FTL) or, more generally, the “media management layer,” as the memory may not be flash) handles flash errors and interfaces with the host. In particular, the FTL, which may be an algorithm in firmware, is responsible for the internals of memory management and translates writes from the host into writes to the memory 104. The FTL may be needed because the memory 104 may have limited endurance, may only be written in multiples of pages, and/or may not be written unless it is erased as a block. The FTL understands these potential limitations of the memory 104, which may not be visible to the host. Accordingly, the FTL attempts to translate the writes from host into writes into the memory 104.

The FTL may include a logical-to-physical address (L2P) map and allotted cache memory. In this way, the FTL translates logical block addresses (“LBAs”) from the host to physical addresses in the memory 104. The FTL can include other features, such as, but not limited to, power-off recovery (so that the data structures of the FTL can be recovered in the event of a sudden power loss) and wear leveling (so that the wear across memory blocks is even to prevent certain blocks from excessive wear, which would result in a greater chance of failure).

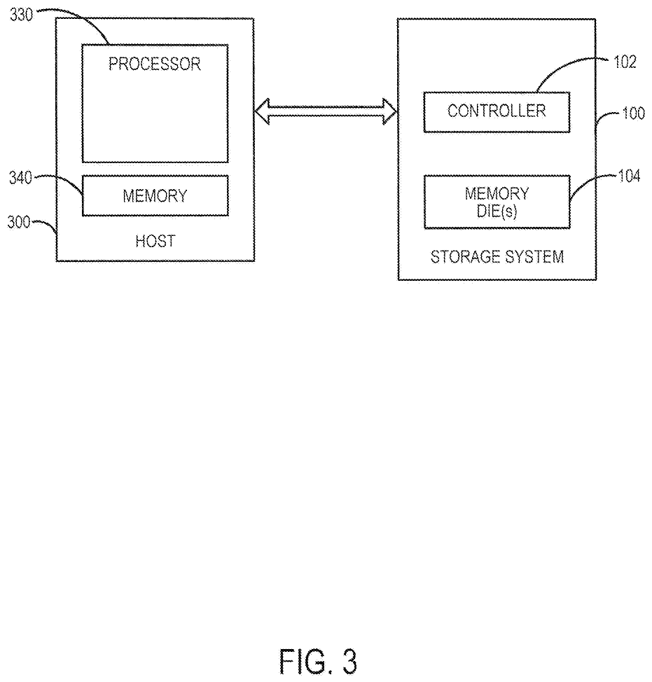

Turning again to the drawings, FIG. 3 is a block diagram of a host 300 and storage system (sometimes referred to herein as a device) 100 of an embodiment. The host 300 can take any suitable form, including, but not limited to, a computer, a mobile phone, a tablet, a wearable device, a digital video recorder, a surveillance system, etc. The host 300 in this embodiment (here, a computing device) comprises a processor 330 and a memory 340. In one embodiment, computer-readable program code stored in the host memory 340 configures the host processor 330 to playback media read from the memory 104 of the storage system 100.

As mentioned above, a playback system can be connected to the host 300 over a network. When the playback system wants to play video data, the playback system sends a request over the network to the host 300. The host 300 retrieves the video data from the memory 104 in the storage system 100 and then sends the video data over the network to the playback system. If bandwidth consumption on the network is high, the video data may need to be buffered on the host 300 until more bandwidth becomes available. So, one of the challenges with streaming content over a network (e.g., the Internet) is that the network connection may lack sufficient bandwidth, resulting in stops, lags, or slow buffering of the content. In addition, different playback systems have different capabilities, and users lacking compatible hardware or software systems may be unable to stream certain content.

The following embodiments can be used to send a reduced version of the data (instead of the data originally stored in the storage system 100) according to various playback conditions. Before turning to example implementations of these embodiments, the following paragraphs provide an overview of one particular type of video format that can be used with these embodiments. It is important to note that this is merely an example, and other types of media formats can be used.

In one example implementation, the data stored in the storage system 100 is governed by the Moving Picture Experts Group (MPEG)-4 Advanced Video Coding (AVC) H.264/H.265 standard. That standard specifies the syntax and decoding schemes for a certain profile or level. A “profile” specifies algorithms and features, and a “level” specifies limitations on the resources (e.g., memory and processor) that a decoder can use related to, for example, resolution, bit rate, and processing speeds. Examples of the various profiles that can be used include a Baseline Profile, an Extended Profile, a Main Profile, a High Profile, etc. The more complicated the profile, the more data is needed to meet the requirements of the profile. For example, a High 4:4:4 Predictive Profile, which supports up to 4:4:4: Chroma sampling, would require much more data than a Baseline Profile. The various supported profiles can be sets of different complexities of decoders and can be determined by parsing a header.

Recognizing that different playback systems have different capabilities, a given video stream can be compatible with several profiles and levels, with the playback system using whatever information in the video stream is suitable for its capability. So, when storing video data in the storage system 100, the host 300 stores the data with the highest possible profile (e.g., High 4:4:4 Predictive Profile (Hi444PP), supporting up to 4:4:4 Chroma sampling). During retrieval and playback, not all playback systems may be willing to play or be capable of playing (e.g., due to decoder bandwidth) such a high profile video. In such cases, the playback system removes or does not use the unnecessary data.

Usually, a level of support within a profile specifies the maximum picture resolution, frame rate, and bit rate that a decoder may use. A decoder that conforms to a given level must be able to decode all bit streams encoded for that level and all lower levels. With respect to bit rates, according to the specification, the maximum bit rate for the High Profile is 1.25 times that of the Baseline and Main Profiles and four times for Hi444PP.

Including all of the data in the data transfer from the storage system 100 provides flexibility, as a playback system simply uses the data it needs and ignores the rest. However, including all of the data may not be optimal for data transfer, especially when there are limitation on bandwidth consumption on the network connecting the host 300 and the playback system. The following embodiments can be used to address this. In short, the host 300 and storage system 100 together would generate a profile consistent with the application use case's quality of service and optimum network bandwidth. Performing these actions in the storage system 100 minimizes the overall data transfer and system latency.

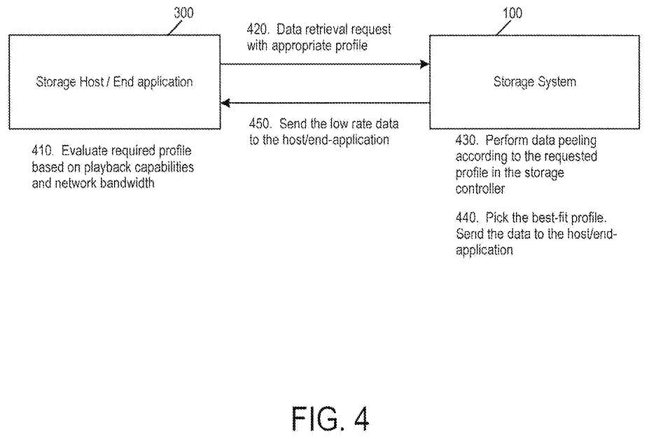

FIG. 4 is a block diagram that illustrates this embodiment. As shown in FIG. 4, the host 300 evaluates the required profile based on playback capabilities of the playback system and/or the network bandwidth (act 410). That is, the host 300 determining a playback condition, which can be, for example, playback capability of the playback system and/or available network bandwidth between the host 300 and the playback system. The host 300 can make this determination, for example, by receiving playback capabilities from the playback system and/or by using known bandwidth detection techniques.

Next, the host 300 sends a data retrieval request to the storage system 100 with the appropriate profile (act 420). That is, based on the determined playback condition, the host 300 sends a request to the storage system 100 for a desired profile (e.g., a specific profile of H.264/H.265 standard) for video data stored in the memory 104 of the storage system 100. The controller 102 in the storage system 100 then performs data peeling according to the requested profile (act 430). For example, the controller 102 can generate a reduced-bit-rate version of the video stored in the memory 104, such that the reduced-bit-rate version of the video would be a better fit for the requested profile than the original version of the video stored in the memory 104. The controller 102 also picks the best-fit profile and sends the data to the host 300 (act 440). This best-fit profile may or may not be the exact profile requested by the host 300. That is, the controller 102 can parse the media data in the context of the bit rate profile, understand the highest profile, and perform necessary data peeling operations to generate, from the stored data, a best profile among many available H.264 profiles consistent with the host request. The peeled data would have a lower bit rate than what was stored, providing a quality of service consistent with the end application and the network usage. The low frame rate data is then sent to the host 300 (act 450), which sends it to the playback system. The storage system 100 can also send a hint to the host 300 regarding the profile it selected.

As can be seen by these examples, these embodiments can be used to improve the quality of service of the storage system 100 in terms of low latency data transfer and best match of data consistent with end applications. Given that more than 80% of the stored data is media-specific, these embodiments can have a lot of value.

There are many alternatives that can be used with these embodiments. For example, while the above sample implementations were described in terms of video data, these embodiments can be used with other types of media files, such as audio data. For example, if the media file contains multichannel audio and stereo, these embodiments can be used to send only the stereo part of the file. This may involve audio decoding and re-encoding. Similarly, these embodiments can be applied to a media file comprising images, sending only necessary data and withholding metadata. In another alternative, the host 300 can just pass the playback capability and/or the network availability to the storage system 100, and the storage system 100 can determine the best matching fit.

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are examples, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and wordlines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

1. A storage system comprising:
a memory; and
a controller configured to:
receive a request from a host for a version of a video stored in the memory that is suitable for a specified profile;
generate a reduced-bit-rate version of the video based on the specified profile after receiving the request from the host;
select a profile, different from the specified profile, that is a best fit for the specified profile;
send the reduced-bit-rate version of the video to the host; and
inform the host of the selected profile.

2. The storage system of claim 1, wherein the specified profile is based on a playback condition determined by the host.

3. The storage system of claim 2, wherein the playback condition comprises available network bandwidth between the host and a playback system.

4. The storage system of claim 2, wherein the playback condition comprises a playback capability of a playback system connected with the host.

5-6. (canceled)

7. The storage system of claim 1, wherein the video comprises an advanced video coding (AVC) video.

8. The storage system of claim 1, wherein the memory comprises a three-dimensional memory.

9. A method comprising;
performing the following in a host in communication with a playback system and a storage system:
determining a playback condition;
based on the determined playback condition, sending a request to the storage system for a desired profile for video data stored in a memory of the storage system;
receiving, from the storage system, a reduced-bit-rate version of the video data and a selected profile, wherein the selected profile is a better fit for the desired profile and the reduced-bit-rate version of the video data is generated by the storage system after receiving the request from the host; and
sending the reduced-bit-rate version of the video data to the playback system.

10. The method of claim 9, wherein the playback condition comprises available network bandwidth between the host and the playback system.

11. The method of claim 9, wherein the playback condition comprises playback capability of the playback system.

12. The method of claim 9, further comprising receiving a hint from the storage system regarding the selected profile.

13. The method of claim 9, wherein the video data comprises advanced video coding (AVC) data.

14. A storage system comprising:
a memory;
means for receiving a request from a host for a version of a video stored in the memory that is suitable for a specified profile;
means for generating a reduced-bit-rate version of the video based on the specified profile after receiving the request from the host;
means for selecting a profile, different from the specified profile, that is a best fit for the specified profile;
means for sending the reduced-bit-rate version of the video to the host; and
means for informing the host of the selected profile.

15-26. (canceled)

27. The storage system of claim 1, wherein the selected profile is selected based on a quality of service requirement of a playback system connected with the host.

28. The storage system of claim 1, wherein the controller is further configured to generate the reduced-bit-rate version of the video using a data peeling operation.

29. The storage system of claim 1, wherein the specified profile and the selected profile are different ones of the following: a baseline profile; an extended profile, a main profile, and a high profile.

30. The method of claim 9, wherein the selected profile is selected based on a quality of service requirement of the playback system.

31. The method of claim 9, further comprising generating the reduced-bit-rate version of the video using a data peeling operation.

32. The method of claim 9, wherein the specified profile and the selected profile are different ones of the following: a baseline profile, an extended profile, a main profile, and a high profile.

33. The method of claim 9, wherein the memory comprises a two-dimensional memory.

34. The method of claim 9, wherein the memory comprises a three-dimensional memory.
